(19) United States
(12) Patent Application Publication
(10) Pub. No.: US 2010/0123292 A1
(43) Pub. Date: May 20, 2010

(54) GASKET

(75) Inventors: Masamitsu Seno, Anjo-shi (JP); Yutaka Hotta, Chiryu-shi (JP); Shuji Yoshitsune, Fukushima-shi (JP)

Correspondence Address: GIFFORD, KRASS, SPRINKLE,ANDERSON & CITKOWSKI, P.C, PO BOX 7021, TROY, MI, 48007-7021, US

(73) Assignees: Toyota Jidosha Kabushiki Kaisha, Toyota-Shi (JP); Aisin AW Co., Ltd., Anjo-Shi (JP); Nok Corporation, Tokyo (JP)

(21) Appl. No.: 12/622,518

(22) Filed: Nov. 20, 2009

(30) Foreign Application Priority Data
Nov. 20, 2008 (JP) 2008-296209

(51) Int. Cl. F16J 15/06

(52) U.S. Cl. 277/650

(57) ABSTRACT

A gasket has an annular metallic frame, and a seal portion made of an elastic material which extends annularly along an inner peripheral portion of the metallic frame, and which is connected to the metallic frame. The metallic frame has a penetration hole through which a shaft portion of a bolt that fastens two surfaces of an appliance that faces each other penetrates, and a seat surface-corresponding portion that is formed around the penetration hole, and that corresponds to a seat surface of the bolt.

### INCORPORATION BY REFERENCE

The disclosure of Japanese Patent Application No. 2008-296209 filed on Nov. 20, 2008 including the specification, drawings and abstract is incorporated herein by reference in its entirety.

### BACKGROUND OF THE INVENTION

1. Field of the Invention

The invention relates to improvement of the structure of a gasket that is compressed and clamped between two surfaces of an appliance that face each other, and that therefore improves the air tightness of the appliance.

2. Description of the Related Art

A gasket compressed and clamped between two surfaces of an appliance that face each other has been known. The gasket has, in a joint portion between two surfaces the appliance that face each other, a seal portion made of an elastic material which has been formed into a shape that conforms to the joint portion. Because the seal portion closely contacts the two surfaces of the appliance that face each other when fastening is realized by a fastening member such as a bolt or the like, the air tightness of the appliance can be improved.

Japanese Patent Application Publication No. 2005-214222 (JP-A-2005-214222) describes a gasket that has a rigid material-made reinforcement ring having insertion holes into which bolts or the like are inserted, and a seal element made of a rubber-like elastic material which extends annularly along an inner peripheral portion of the reinforcement ring, and which is firmly stuck to the reinforcement ring. The reinforcement ring is provided with a plurality of cutout portions that make the reinforcement ring discontinuous in the circumferential direction. This configuration causes the reinforcement ring to be deformable in a diameter-increasing direction and a diameter-decreasing direction, or the like, when the gasket is attached to an appliance, so that the operability at the time of the attachment operation can be improved.

In the gasket described in Japanese Patent Application Publication No. 2005-214222 (JP-A-2005-214222), the seal element is positioned radially inwardly of the inner peripheral portion of the insertion hole formed in the reinforcement ring. Since in this positional relationship, the seal element closely contacts, without a gap, the two surfaces of the appliance that face each other, air tightness of the appliance is maintained without forming a gap that connects an insertion hole and an interior of the appliance.

In conjunction with the gasket constructed as described above, it sometimes happens that the seal portion hangs over the seat surface of a bolt that is inserted into an insertion hole, via the joint portion between the two surfaces of the appliance that face each other. In such a case, friction may occur between the seal element that the two surface of the appliance that face each other due to vibration of the appliance or the like, so that the friction may degrade the seal element, and may reduce the thickness of the seal element. Then, as the thickness of the seal element lying on the seat surface of the bolt reduces, the axial force of the bolt declines, so that the bolt loosens. As a result, a gap that connects between the exterior and the interior of the appliance is formed, giving rise to a problem of impairment of air tightness of the appliance.

### SUMMARY OF THE INVENTION

The invention provides a gasket that is able to restrain the loosening of a bolt caused by vibration of an appliance and secure air tightness of the appliance, while having a simple structure.

A gasket of a first aspect of the invention which is compressed and clamped between two surfaces of an appliance that face each other so as to improve air tightness of the appliance includes: an annular metallic frame that has a penetration hole through which a shaft portion of a fastening member that fastens the two surfaces penetrates, and a seat surface-corresponding portion that is formed around the penetration hole, and that corresponds to a seat surface of the fastening member; and a seal portion made of an elastic material which annularly extends along an inner peripheral portion of the metallic frame, and which is connected to the metallic frame.

A gasket of a second aspect of the invention which is compressed and clamped between two surfaces of an appliance that face each other so as to improve air tightness of the appliance includes: a plurality of metallic frames which are separately disposed annularly, and each of which has a penetration hole through which a shaft portion of a fastening member that fastens the two surfaces penetrates, and a seat surface-corresponding portion that is formed around the penetration hole, and that corresponds to a seat surface of the fastening member; and a seal portion made of an elastic material which extends annularly so as to interlink an inward portion of each metallic frame, and which is connected to the metallic frames.

The seal portion may be greater than a thickness of the metallic frame.

The fastening member may be a bolt.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a diagram showing a configuration of a gasket in accordance with an embodiment of the invention;

FIG. 2 is a sectional view taken on line 2A-2A in FIG. 1;

FIG. 3 is a sectional view showing a state in which the gasket is clamped in an appliance;

FIG. 4 is an enlarged view of a portion of the gasket;

FIG. 5 is a diagram showing a configuration of a gasket in accordance with another embodiment of the invention; and

FIG. 6 is an enlarged view of a portion of the gasket.

### DETAILED DESCRIPTION OF EMBODIMENTS

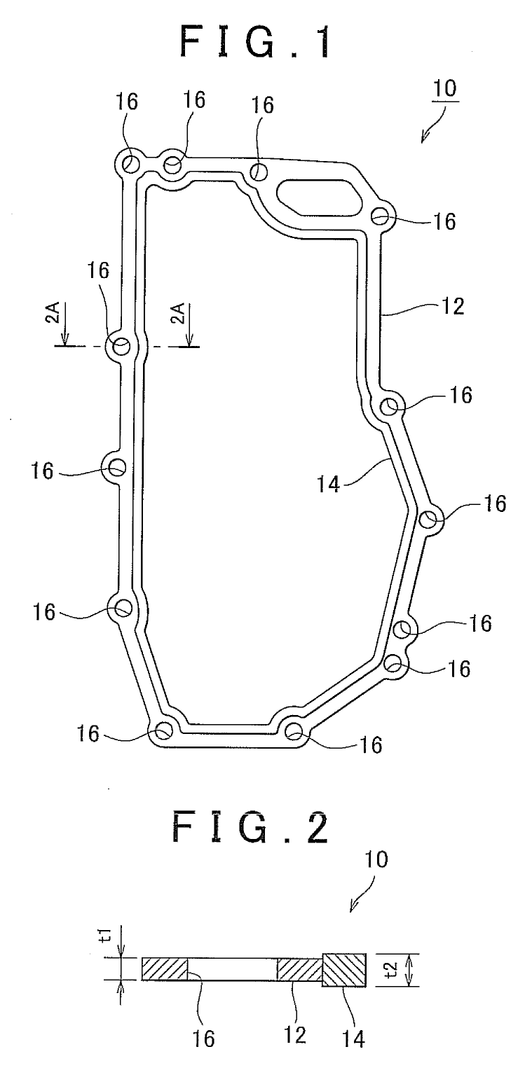

Embodiments of the gasket of the invention will be described hereinafter with reference to the drawing. FIG. 1 is a diagram showing a construction of a gasket 10 in accordance with an embodiment of the invention. FIG. 2 is a sectional view taken on line 2A-2A in FIG. 1.

The gasket 10 has an annular metallic frame 12, and a seal portion 14 that extends annularly along an inner peripheral portion of the metallic frame 12 and that is connected to the metallic frame 12.

The metallic frame 12 is constructed of a thin metal sheet, such as a stainless steel sheet, a mild steel sheet, an iron sheet, etc. A plurality of penetration holes 16 through each of which a shaft portion of a bolt (described below) is inserted are formed in the metallic frame 12. The seal portion 14 is constructed of an elastic material such as rubber or the like. The metallic frame 12 and the seal portion 14 are firmly stuck to each other by an adhesive.

As shown in FIG. 2, a thickness t2 of the seal portion 14 is greater than a thickness t1 of the metallic frame 12. Therefore, in the case where the gasket 10 is compressed and clamped between two surfaces of an appliance (described below) that face each other, the seal portion 14 is certainly compressed in the thickness direction, so that due to the compression, the seal portion 14 is able to closely contact by close contact force that is uniform between the two surfaces.

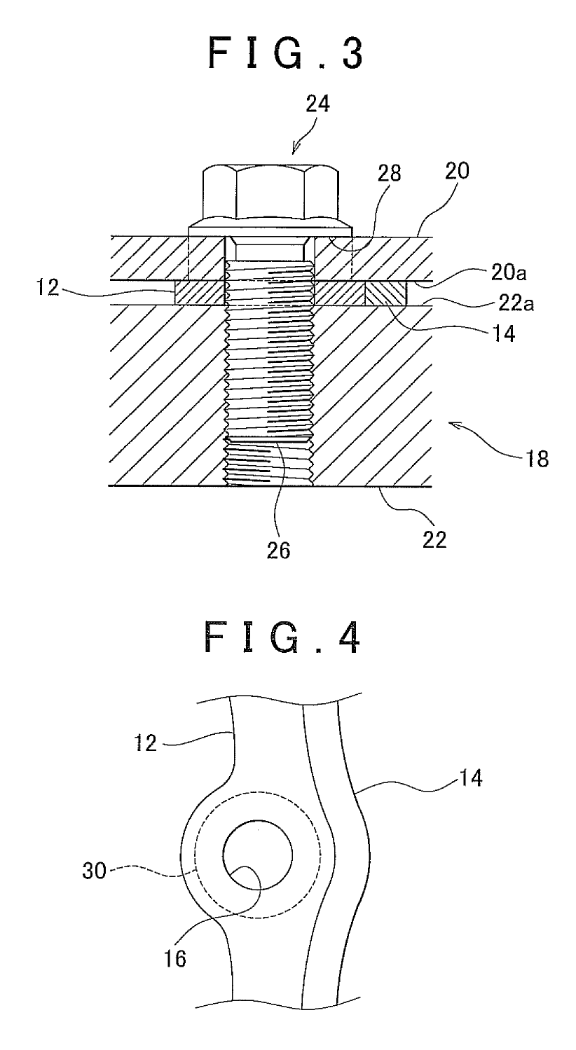

A state in which the gasket 10 constructed as described above is clamped in an appliance 18 will be described with reference to FIG. 3.

The appliance 18 is constructed of an upper appliance 20 and a lower appliance 22. A lower end of the upper appliance 20 and an upper end of the lower appliance 22 are provided with surfaces that face each other. These surfaces are surfaces that are joined with each other via the gasket 10 provided therebetween as described below. Therefore, that surface of the upper appliance 20 is termed herein the upper appliance joint surface 20a, and the surface of the lower appliance 22 is termed the lower appliance joint surface 22a. It is to be noted herein that the upper appliance 20 may be a lid and the lower appliance 22 may be an appliance main body, and the lid may be detachable and attachable with respect to the appliance main body.

The gasket 10 is inserted in a joint portion between the upper appliance joint surface 20a and the lower appliance joint surface 22a. Then, a shaft portion 26 of a bolt 24 is inserted into a penetration hole 16 from the upper appliance 20 into the lower appliance 22 via the gasket 10, and then the bolt 24 is fastened. Therefore, the upper appliance 20 is fixed to and integrated with the lower appliance 22. In addition, in this embodiment, the bolts 24 are used as means for fixing the upper appliance 20 and the lower appliance 22. the fixing means is not limited so, but may also be screws, or the like.

As described above in conjunction with the related art, in a related-art gasket, the seal portion may sometimes hang over the seat surface of a bolt, via the joint portion between the two surface of the appliance that face each other. A portion of the seal portion that hangs over the seat surface of a bolt receives a compression load from the seat surface of the bolt. Therefore, due to vibration of the appliance or the like, large friction becomes likely to occur between the seal portion and the two surfaces of the appliance that face each other. This friction will degrade the seal portion, and will reduce the thickness of the seal portion. Then, as the thickness of the seal portion hanging over the seat surface of a bolt reduces, the axial force of the bolt declines, so that the bolt loosens. As a result, a gap that connects between the exterior and the interior of the appliance is formed, giving rise to a problem of impairment of air tightness of the appliance.

The gasket 10 in accordance with this embodiment of the invention is characterized in that the metallic frame 12 of the gasket 10 is provided with portions that correspond to the seat surfaces 28 of the bolts 24. A portion of the metallic frame 12 that corresponds to the seat surface 28 of a bolt 24 is a portion of the metallic frame 12 that reflects the projection of the seat surface 28 of the bolt 24 in the axis direction as shown in FIG. 3. These portions of the metallic frame 12 are formed in a circular shape surrounding a penetration hole 16, as shown by reference numeral 30 in FIG. 4. The portions represented by the reference characters 30 are hereinafter termed the seat surface-corresponding portions 30.

Thus, because the seat surface-corresponding portions 30 are formed in the metallic frame 12, the seat surface-corresponding portions 30 are able to certainly receive the compression load from the seat surfaces 28 of the bolts 24. Since each seat surface-corresponding portion 30 receives compression load from the corresponding seat surface 28, the seal portion 14 positioned on the inner peripheral portion of the metallic frame 12 receives reduced influence of the compression load from the seat surface 28 of the seal portion 14. Therefore, the friction caused between the appliance 18 and the seal portion 14 due to vibration of the appliance 18 or the like becomes unlikely to occur, so that degradation of the seal portion 14 is restrained. As degradation of the seal portion 14 is restrained, decrease of the axis force of the bolts 24 is restrained. As a result, the gasket 10 constructed as described above is less likely to be affected by external factors such as vibration or the like, so that air tightness of the appliance 18 can be secured.

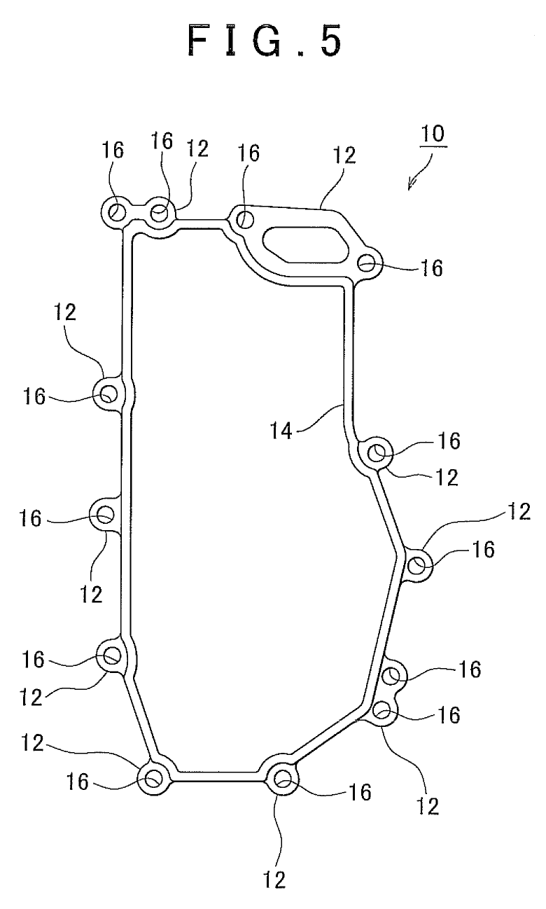

Although the gasket 10 of this embodiment has been described in conjunction with a configuration in which the shape of the metallic frame 12 is annular, this configuration is not restrictive. For example, separate annular metallic frames 12 may be disposed. In a gasket 10 constructed in this manner, each metallic frame 12 has a shape as shown in FIG. 5.

FIG. 5 is a diagram showing a configuration of the gasket 10 in another embodiment of the invention. Component elements of this embodiment that are substantially the same as those of the foregoing embodiment are represented by the same reference characters, and detailed descriptions thereof are omitted below.

Metallic frames 12 are disposed only at sites at each of which upper and lower appliances (not shown) are fastened together by a bolt (not shown). This configuration considerably reduces the amount of metal that is used for the metallic frames 12. Hence, the weight of the gasket 10 can be reduced, and the cost of materials can be cut down.

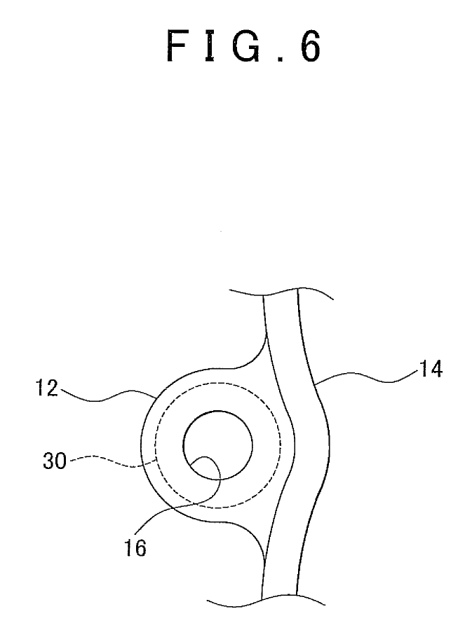

Besides, as shown in FIG. 6, each metallic frame 12 is provided with a seat surface-corresponding portion 30 described above in conjunction with the foregoing embodiment. Hence, as described above in conjunction with the foregoing embodiment, this embodiment is also less likely to be affected by external factors such as vibration or the like, so that air tightness of the appliance 18 can be secured.

In this embodiment, an outer peripheral portion of the seal portion in a view taken in fastening direction, when the fastening member is fastened, may be positioned inwardly of the seat surface of the fastening member.

What is claimed is:

1. A gasket compressed and clamped between two surfaces of an appliance that face each other so as to improve air tightness of the appliance, comprising:
an annular metallic frame that has a penetration hole through which a shaft portion of a fastening member that fastens the two surfaces penetrates, and a seat surface-corresponding portion that is formed around the penetration hole, and that corresponds to a seat surface of the fastening member; and
a seal portion made of an elastic material which annularly extends along an inner peripheral portion of the metallic frame, and which is connected to the metallic frame.

2. The gasket according to claim 1, wherein, an outer peripheral portion of the seal portion in a view taken in fastening direction, when the fastening member is fastened, is positioned inwardly of the seat surface of the fastening member.

3. The gasket according to claim 1, wherein a thickness of the seal portion is greater than a thickness of the metallic frame.

4. The gasket according to claim 1, wherein the fastening member is a bolt.

5. A gasket compressed and clamped between two surfaces of an appliance that face each other so as to improve air tightness of the appliance, comprising:
a plurality of metallic frames which are separately disposed annularly, and each of which has a penetration hole through which a shaft portion of a fastening member that fastens the two surfaces penetrates, and a seat surface-corresponding portion that is formed around the penetration hole, and that corresponds to a seat surface of the fastening member; and
a seal portion made of an elastic material which extends annularly so as to interlink an inward portion of each metallic frame, and which is connected to the metallic frames.

6. The gasket according to claim 5, wherein, an outer peripheral portion of the seal portion in a view taken in fastening direction, when the fastening member is fastened, is positioned inwardly of the seat surface of the fastening member.

7. The gasket according to claim 5, wherein a thickness of the seal portion is greater than a thickness of the metallic frame.

8. The gasket according to claim 5, wherein the fastening member is a bolt.
